(19) United States
(12) Patent Application Publication
(10) Pub. No.: US 2004/0179632 A1
(43) Pub. Date: Sep. 16, 2004

(54) Non-coherent FSK demodulator and demodulating method

(76) Inventors: David Shiung, Tainan (TW); Yung-Lung Chen, Taipei (TW); Wunchi Lin, Ilan (TW); Vicky Chang, Changhua City (TW)

Correspondence Address: J.C. Patents, Inc., Suite 250, 4 Venture, Irvine, CA, 92618, US

(21) Appl. No.: 10/441,538

(22) Filed: May 19, 2003

(30) Foreign Application Priority Data
Mar. 14, 2003 (TW) 92105572

(51) Int. Cl. H04L 27/14

(52) U.S. Cl. 375/334; 329/300

(57) ABSTRACT

A non-coherent frequency shift key demodulator, which includes a digital limiter and a decision logic circuit is disclosed. The digital limiter is used for receiving a baseband signal with a digital signal conveyed therein and comparing the baseband signal with a reference level in order to output a frequency-modulated rectangular pulse. The decision logic circuit, coupled to the digital limiter, is used for receiving the rectangular pulse and counting the transformation of the rectangular pulse to obtain a cycle period, wherein the cycle period is compared with a threshold value to determine the digital signal carried in the baseband signal.

### CROSS-REFERENCE TO RELATED APPLICATION

This application claims the priority benefit of Taiwan application serial no. 92105572, filed Mar. 14, 2003.

### BACKGROUND OF THE INVENTION

1. Field of the Invention

The present invention relates to a demodulator for a communication system. More particularly, the present invention relates to a non-coherent frequency shift key demodulator and a demodulating method.

2. Description of Related Art

For transmitting signals in a wireless communication system, digital signals will be modulated with a carrier signal first and then be transmitted therewith. For example, a frequency shift key (“FSK”) modulation method is commonly used for such modulation. In the FSK modulation, a logical high level or a logical low level of the digital signal desired to be transmitted will be modulated with a carrier signal and then become a modulated carrier signal respectively with a first frequency F1 or a second frequency F2, which depends on the logic level of the digital signal. The modulated carrier signal will be transmitted by a transmitter and received by a receiver in the wireless communication.

Refer to FIG. 1, showing block diagrams of a conventional FSK receiver. The FSK receiver 100 includes a receiving antenna 110, a low noise amplifier 120, a mixer 130, a low-pass filter 140, an analog-to-digital converter 150 and a demodulator 160. The antenna 110 is used for receiving a radio-frequency (RF) signal transmitted by a transmitter. The RF signal is amplified by the low noise amplifier 120 and then is mixed with a local oscillating (LO) signal fc with a LO frequency by the mixer 130. The mixed RF signal is then filtered by the low-pass filter 140 and sampled by the analog-to-digital converter 150, by which a baseband signal B in the carrier signal is then obtained. The baseband signal B with either the first frequency F1 or the second frequency F2 will be demodulated by the demodulator 160 for obtaining the digital signal transmitted by the transmitter, which is modulated in the RF signal.

There are at least two kinds of the demodulator 160 can be used in the FSK receiver 100, which are shown respectively in FIG. 2 and FIG. 3. Referring to FIG. 2, which shows block diagrams of a conventional demodulator using a correlation receiver. Referring to FIG. 3, which shows block diagrams of a conventional demodulator using a discrimination detector.

Referring to FIG. 2, the demodulator 160 includes a first correlator 210, a second correlator 220 and a comparator 230. An integral circuit is respectively used in the first correlator 210 and the second correlator 220 for calculating a correlation value of the baseband signal B, which has the first frequency F1 or the second frequency F2, respectively representing the logic high level or the log low level. The comparator 230 compares the correlation values output from the first correlator 210 and the second correlator 220, in order to obtain the digital signal D in the RF signal.

Referring to FIG. 3, the demodulator 160 includes a discriminator 310 and a decision logic 320. A differential circuit is used in the discriminator 310 for calculating the baseband signal B, which has the first frequency F1 or the second frequency F2, in a time domain to obtain a differential value. The differential value is proportional to the first frequency F1 and the second frequency F2. The decision logic 320 will obtain the digital signal D in the RF signal by judging the differential value output from the discriminator 310.

It is obvious that the conventional demodulator 160 requires a complicated circuit for calculating and obtaining the digital signal, for example, the integral circuit in the demodulator of FIG. 2 or the differential circuit in the demodulator of FIG. 3.

### SUMMARY OF THE INVENTION

Accordingly, one of the purposes of the present invention is to provide a non-coherent frequency shift key demodulator and demodulating method thereof, which is implemented by a neat and simple circuit is required, as compared to the conventional correlation receiver or the conventional discrimination detector, for exactly extracting information conveyed in the incoming signals.

One of the purposes of the present invention is to provide a non-coherent frequency shift key demodulator and demodulating method thereof, which is robust in combating miscellaneous system defects, such as frequency offset, by using a simple look-up table that records the corresponding entities. The demodulator and demodulating method has a very much larger tolerance with the frequency offset, as compared to the conventional correlation receiver or the conventional discrimination detector.

One of the purposes of the present invention is to provide a non-coherent frequency shift key demodulator and demodulating method thereof, which supports multi-rate transmissions as compared to the conventional correlation receiver.

In accordance with the above-mentioned purposes, the present invention provides a non-coherent frequency shift key demodulator, which includes a digital limiter and a decision logic circuit. The digital limiter is used for receiving a baseband signal with a digital signal conveyed therein and comparing the baseband signal with a reference level in order to output a frequency-modulated rectangular pulse. The decision logic circuit, coupled to the digital limiter, is used for receiving the rectangular pulse and counting the transformation of the rectangular pulse to obtain a cycle period, wherein the cycle period is compared with a threshold value to determine the digital signal carried in the baseband signal.

In an alternative embodiment, if the baseband signal has a first frequency f1 or a second frequency f0, respectively representing a high level and a low level, and a system frequency is fs, the predetermined threshold value THR can be determined as fs/[(f1+f0)/2].

In an alternative embodiment, a low-level digital signal is determined if a number of the cycle periods is larger than the threshold value, and a high-level digital signal is determined if the number of the cycle periods is smaller than the threshold value.

In an alternative embodiment, the rectangular pulse is in a status of a low level representing “−1” if the baseband signal lower than the reference level, and the rectangular pulse is in a status of a high level representing “1” if the baseband signal is higher than the reference level.

For achieving the above purpose, the present invention further provides a non-coherent frequency shift key demodulating method, which is adaptive for a frequency-modulated baseband signal to be demodulated to obtain a digital signal thereby. The method includes comparing the baseband signal with a reference level to output a frequency-modulated rectangular pulse; determining a cycle period by counting the transformation of the rectangular pulse; and comparing the number of the cycle period with a threshold value to determine the digital signal carried in the baseband signal.

In an alternative embodiment, if the baseband signal has a first frequency f1 or a second frequency f0, respectively representing a high level and a low level, and a system frequency is fs, the predetermined threshold value THR can be determined as fs/[(f1+f0)/2].

In an alternative embodiment, a low-level digital signal is determined if a number of the cycle periods is larger than the threshold value, and a high-level digital signal is determined if the number of the cycle periods is smaller than the threshold value.

In an alternative embodiment, the rectangular pulse is in a status of a low level representing “−1” if the baseband signal lower than the reference level, and the rectangular pulse is in a status of a high level representing “1” if the baseband signal is higher than the reference level.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows block diagrams of a conventional FSK receiver.

FIG. 2 shows block diagrams of a conventional demodulator using correlation receivers.

FIG. 3 shows block diagrams of a conventional demodulator including a discrimination detector.

FIG. 4 shows block diagrams of a non-coherent frequency shift key (“FSK”) demodulator of a preferred embodiment of the present invention.

FIG. 5 shows an input/output waveform diagram of a digital limiter of a preferred embodiment of the invention.

FIG. 6 shows rectangular pulses demodulated by the non-coherent frequency shift key demodulator and demodulating method of the preferred embodiment of the present invention if digital data stream “1001110111” is carried in a baseband signal.

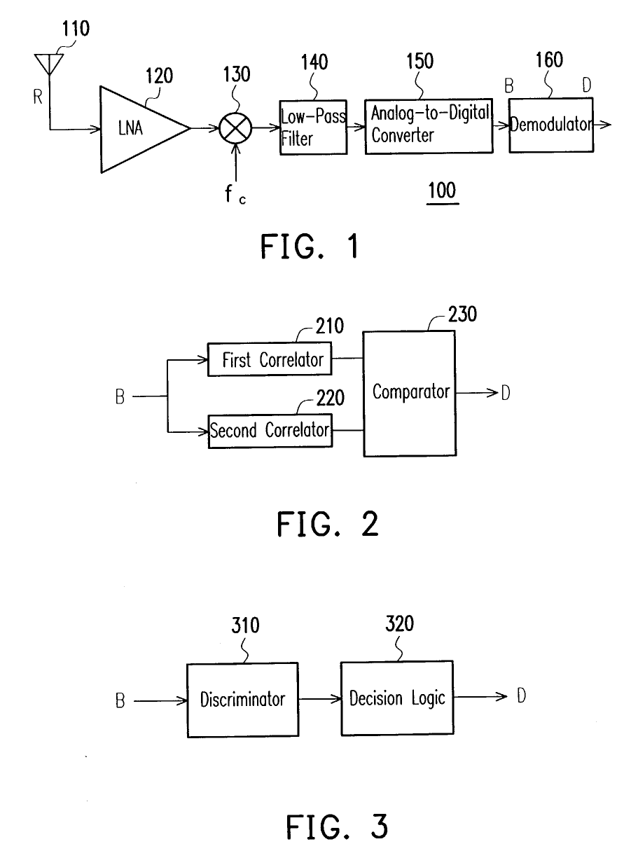

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

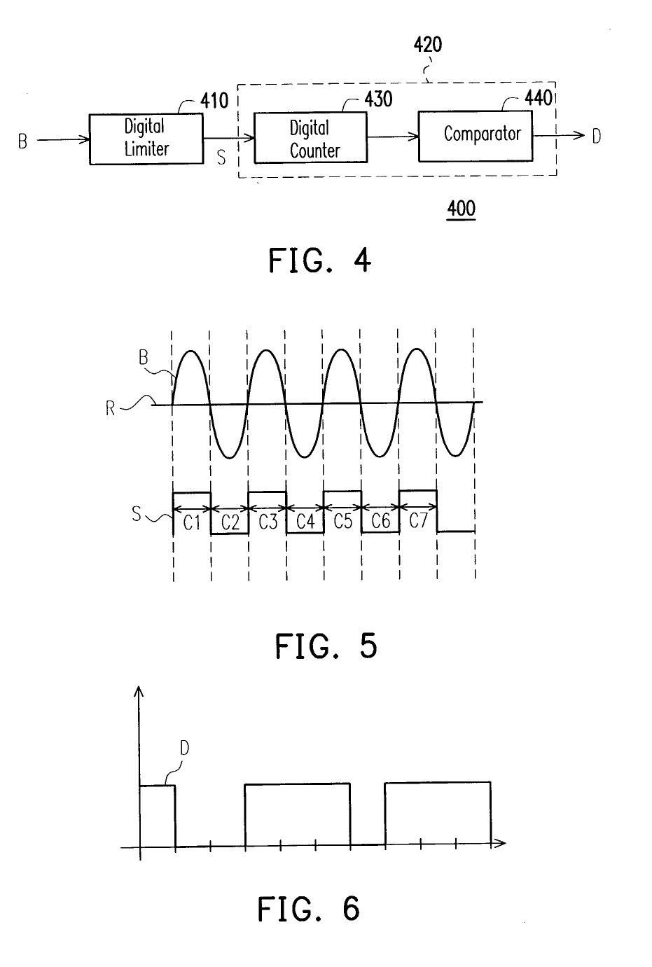

Referring to FIG. 4, which shows block diagrams of a non-coherent frequency shift key (“FSK”) demodulator of a preferred embodiment of the present invention. Received radio-frequency (RF) signal is first down-converted to a baseband frequency and is denoted as baseband signal B. The non-coherent FSK demodulator 400 can demodulate the baseband signal B, which has a first frequency f1 or a second frequency f2 output from an analog-to-digital converter, for example, the analog-to-digital converter 150 as shown in FIG. 1. A digital signal D transmitted from a transmitter (not shown) is conveyed in the received baseband signal B and extracted by the non-coherent FSK demodulator 400. For clearly explaining the invention in the following description, it is assumed that if the digital signal D is a logic high signal representing “1”, the frequency of the baseband signal B is the first frequency f1, and if the digital signal D is a logic low signal representing “0”, the frequency of the baseband signal B is the second frequency f2.

As shown in FIG. 4, the non-coherent FSK demodulator 400 includes at least a digital limiter 410 and a decision logic circuit 420. A digital counter 430 and a comparator 440 implement the decision logic circuit 420, in the preferred embodiment. The operation method of the preferred embodiment is explained in accompanying with waveform diagrams respectively shown in FIG. 5 and FIG. 6, as followed.

Referring to FIG. 5, which shows an input/output waveform diagram of the digital limiter 410 of the preferred embodiment of the invention. The sampled baseband signal B output from the analog-to-digital converter, such as the analog-to-digital converter 150 of FIG. 1, is transmitted to the digital limiter 410 and is then compared with a reference level R of the digital limiter 410, in order to output a rectangular pulse S with a modulated frequency. In a case that if the reference level R is configured to be “0”, the rectangular pulse S is in a status of a low level representing “−1” if the sampled baseband signal B is lower than the reference level R, i.e., “0”. On the contrary, the rectangular pulse S is in a status of a high level representing “1” if the sampled baseband signal B is higher than the reference level R, i.e., “0”. Thus, the waveform diagram of the signal S is then determined, as shown in FIG. 5.

The rectangular pulse S is then transmitted to the digital counter 430 of FIG. 4, and then a cycle period is determined by counting the transformation of each of the rectangular pulse S, with reference to a system frequency for counting in the digital counter 430, for example, c1, c2, c3, c4, c5, c6 and c7 as shown in FIG. 5. The cycle periods, for example, c1, c2, c3, c4, c5, c6 and c7, are compared with a threshold value predetermined in the comparator 440 and the digital signal D is then demodulated thereby.

If the baseband signal B has a first frequency f1 or a second frequency f0, respectively representing a high level and a low level, and a system frequency is fs, the predetermined threshold value THR can be determined as fs/[(f1+f0)/2]. For example, if the digital signal is in a status of the high level representing “1”, the frequency of the baseband signal B is 14 KHz, and if the digital signal is in a status of the low level representing “0”, the frequency of the baseband signal B is 6 KHz, and the system frequency fs is equal to 1.2 MHz, the predetermined threshold value THR can be determined as 1.2 MHz/[(14K+6K)/2]=120.

The above-mentioned example is further explained as followed. If the digital signal D is in the status of the high level, the number of the cycle periods can be determined as 85 by dividing the system frequency fs with the frequency of the baseband signal B, i.e., dividing 1.2 MHz with 14K Hz. The number of the total cycle periods is smaller than the predetermined threshold value THR, i.e., 120 in the foregoing exemplary case. If the digital signal D is in the status of the low level, the number of the cycle periods can be determined as 200 by dividing the system frequency fs with the frequency of the baseband signal B, i.e., dividing 1.2 MHz with 6 KHz. The number of the total cycle periods is larger than the predetermined threshold value THR, i.e., 120 in the foregoing exemplary case. Therefore, a low-level digital signal can be determined if the number of the cycle periods which can be accounted is larger than the predetermined threshold value THR, and a high-level digital signal can be determined if the number of the cycle periods which can be accounted is smaller than the predetermined threshold value THR. The digital signal D carried by the baseband signal B can be demodulated by comparing the number of the cycle periods with the predetermined threshold value THR.

As mentioned above, it is concluded that a non-coherent frequency shift key demodulating method is introduced in the preferred embodiment. The demodulating method is adaptive for a frequency-modulated baseband signal to be demodulated to obtain a digital signal thereby. The non-coherent FSK demodulating method includes the following steps. First, the baseband signal is compared with a predetermined level to output a frequency-modulated rectangular pulse. Secondly, a cycle period is then determined in according to the transformation of each of the rectangular pulse. The number of the cycle periods is then compared with a predetermined threshold value, in order to determine the digital signal carried in the baseband signal.

If the baseband signal B has a first frequency f1 or a second frequency f0, respectively representing a high level and a low level, and the system frequency is fs, the predetermined threshold value THR can be determined as fs/[(f1+f0)/2]. In a case that if the reference level R is assumed to be “0”, the rectangular pulse S is in a status of a low level representing “−1” if the sampled baseband signal B is lower than the reference level R, i.e., “0”. On the contrary, the rectangular pulse S is in a status of a high level representing “1” if the sampled baseband signal B is higher than the reference level R, i.e., “0”.

If the transmitted bit stream is “1001110111”, rectangular pulses demodulated by the non-coherent frequency shift key demodulator and demodulating method of the preferred embodiment of the present invention are as shown in FIG. 6. It is apparent that only simple circuit is required for exactly demodulating the digital signal carried in the baseband signal by applying the non-coherent FSK demodulator or method of the invention with a significant high frequency offset.

Accordingly, the non-coherent frequency shift key demodulator of the preferred embodiment can be implemented by a neat and simple logic circuit, as compared to the conventional correlation receiver or the conventional discrimination detector, for exactly extracting information conveyed in the incoming signals. The non-coherent frequency shift key demodulator and demodulating method is robust in combating miscellaneous system defects, such as frequency offset, by using a simple look-up table that records the corresponding entities. The demodulator and demodulating method has a very much larger tolerance with the frequency offset, as compared to the conventional correlation receiver or the conventional discrimination detector. In addition, the demodulator and demodulating method also supports multi-rate transmissions as compared to the conventional correlation receiver.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A non-coherent frequency shift key demodulator, comprising:
a digital limiter, for receiving a baseband signal comprising a digital signal therein and comparing the baseband signal with a reference level in order to output a frequency-modulated rectangular pulse; and
a decision logic circuit, coupled to the digital limiter, for receiving the rectangular pulse and counting the transformation of the rectangular pulse to obtain a cycle period, wherein the cycle period is compared with a threshold value to determine the digital signal of the baseband signal.

2. The non-coherent frequency shift key demodulator of claim 1, wherein if the baseband signal has a first frequency f1 or a second frequency f0, respectively representing a high level and a low level, and a system frequency is fs, the predetermined threshold value THR can be determined as fs/[(f1+f0)/2].

3. The non-coherent frequency shift key demodulator of claim 1, wherein a low-level digital signal is determined if a number of the cycle periods is larger than the threshold value, and a high-level digital signal is determined if the number of the cycle periods is smaller than the threshold value.

4. The non-coherent frequency shift key demodulator of claim 1, wherein the rectangular pulse is in a status of a low level representing “−1” if the baseband signal lower than the reference level, and the rectangular pulse is in a status of a high level representing “1” if the baseband signal is higher than the reference level.

5. The non-coherent frequency shift key demodulator of claim 1, wherein the decision logic circuit comprising:
a digital counter, for counting the transformation of the rectangular pulse with reference to a system frequency to obtain the cycle period; and
a comparator, coupled to the digital counter, for comparing the number of the cycle period with the threshold value to determine the digital signal.

6. A non-coherent frequency shift key demodulating method, which is adaptive for a frequency-modulated baseband signal to be demodulated to obtain a digital signal thereby, the method comprising:
comparing the baseband signal with a reference level to output a frequency-modulated rectangular pulse;
determing a cycle period by counting the transformation of the rectangular pulse; and
comparing the number of the cycle period with a threshold value to determine the digital signal of the baseband signal.

7. The non-coherent frequency shift key demodulating method of claim 6, wherein if the baseband signal has a first frequency f1 or a second frequency f0, respectively representing a high level and a low level, and a system frequency is fs, the predetermined threshold value THR can be determined as fs/[(f1+f0)/2].

8. The non-coherent frequency shift key demodulating method of claim 6, wherein a low-level digital signal is determined if a number of the cycle periods is larger than the threshold value, and a high-level digital signal is determined if the number of the cycle periods is smaller than the threshold value.

9. The non-coherent frequency shift key demodulating method of claim 6, wherein the rectangular pulse is in a status of a low level representing “−1” if the baseband signal lower than the reference level, and the rectangular pulse is in a status of a high level representing “1” if the baseband signal is higher than the reference level.
